(19) United States
(12) Patent Application Publication
(10) Pub. No.: US 2007/0095486 A1
(43) Pub. Date: May 3, 2007

(54) Single cord activation mechanism for collecting a window blind

(75) Inventors: Hsien-Te Huang, Taipei (TW); Wen-Ying Liang, Fu Hsing (TW); Sheng-Ying Hsu, Fu Hsing (TW)

Correspondence Address: Troxell Law Office Pllc, Suite 1404, 5205 Leesburg Pike, Falls Church, VA, 22041, US

(73) Assignee: Ching Feng Home Fashions Co., Ltd.

(21) Appl. No.: 11/263,921

(22) Filed: Nov. 2, 2005

(51) Int. Cl. E06B 9/30

(52) U.S. Cl. 160/171

(57) ABSTRACT

A single cord activation mechanism for collecting a window blind, especially a mechanism which uses a single cord to collect slats of a window blind, is primarily composed of a release shaft with a larger diameter which is connected coaxially with an activation shaft. The entire structure is located in a top rail longitudinally. The release shaft provides for winding a lifting cord for opening and closing the slats. The activation shaft provides for winding an activation cord through an arresting member. A linear length of releasing operation can be enlarged by increasing the diameter of activation shaft, and a height of operation can be safely and easily acquired according to opening and closing the slats with the single activation cord.

### BACKGROUND OF THE INVENTION

(a) Field of the Invention

The present invention relates to a single cord activation mechanism for collecting a window blind, and more particularly to a mechanism which is used to operate a release of slats of a window blind by a method of single cord activation. The mechanism includes primarily a reel which is connected to the slats through a lifting cord, and whose one end is operated by an activation shaft with a smaller diameter, through a single activation cord. The slats can be opened by themselves with their deadweights, whereas they are collected through acting on the activation shaft and the reel associated therewith by the single activation cord, thereby achieving purposes of enlarging speed and collecting with safety.

(b) Description of the Prior Art

An operation of opening slats of a horizontal window blind can be performed manually or electrically. The manual operation is shown in FIG. 1, wherein pluralities of slats 10 are located below a top rail 1. A pull cord 2 links with each slat 10 and passes through a penetration 15 on the top rail 1, and then reeves on an arresting member 100 to extend with an active pull cord 20. There are at least two active pull cords according to the quantity of pull cords. Therefore, two cords extended from the pull cord 2 will be accumulated at the position of active pull cord 20. The arresting member 100 creates a locking function to lock on any position of a section of the active pull cord 20, so as to position the slats 10 in a half-open or full-open status.

The slats 10 can be dropped down by the deadweight effect associated with the gravity of earth. However, upon collecting slats 10, the active pull cord 20 is used to pull up the slats 10 to stack them upward to achieve a purpose of collecting.

As the active pull cord 20 is made by two cords 200, a tangle will usually be formed between them. In addition, since an activation stroke of the active pull cord 20 is the same as a collecting/releasing stroke of the slats 10, a certain length will be dropped down for the active pull cord 20 after collecting the slats 10, thereby forming a free hanging cord and causing a danger of winding and tying limbs of kids due to playing.

Referring to FIG. 2, a recent method of electrically operating a window blind is to use a motor 13 to drive a reel 11 through a polygonal driving shaft 12. An inner hole of the reel 11 provides for the driving shaft 12 to rotate radially, and the reel 11 is supported by a sliding seat 14 which is movable. The entire mechanism is installed inside a top rail 1 and can slide longitudinally. An outer surface of the reel 11 provides for a winding of a lifting cord 16 which passes through each slat 10 and combines with a ladder string 160 to position the slats 10 in an equal distance. As the motor 13 requires electricity, the mechanism will lose its convenience under a blackout condition.

### SUMMARY OF THE INVENTION

In lieu of the aforementioned inconvenience of conventional collecting mechanisms, the present invention uses a single cord operation method to open and close the slats, whereas the slats can be dropped down by using the deadweight effect of slats themselves. In addition, the reel is driven to collect the slats by acting on the activation shaft through the single activation cord. The working principle is to use a shear force between strands of lifting cord to form a horizontal component of force, which in turn drives the reel to shift longitudinally, during the process of collecting the slats. In addition, the diameter of reel is larger than that of the activation shaft, therefore a linear velocity (length) of the activation cord can be enlarged by an enlargement of the reel, thereby providing a fast operation and shortening a length at lower end of the activation cord.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of an activation mechanism of a conventional horizontal window blind.

FIG. 2 shows a perspective view of a conventional method of collecting slats electrically.

FIG. 3 shows a side view of the present invention.

FIG. 4 shows a schematic view of operation of a lifting cord of the present invention.

FIG. 5 shows a force diagram of FIG. 4.

FIG. 6 shows a schematic view of a release shaft driving a lifting cord of the present invention.

FIG. 7 shows a force diagram of FIG. 6.

FIG. 8 shows an end view of a relationship between a release shaft and an activation shaft of the present invention.

FIG. 9 shows a side view of FIG. 8.

FIG. 10 shows a schematic view of a release shaft after dropping down slats of the present invention.

FIG. 11 shows a comparison between a stroke of lifting cord and a stroke of activation cord.

FIG. 12 shows a side view of screws of another implementation of the present invention.

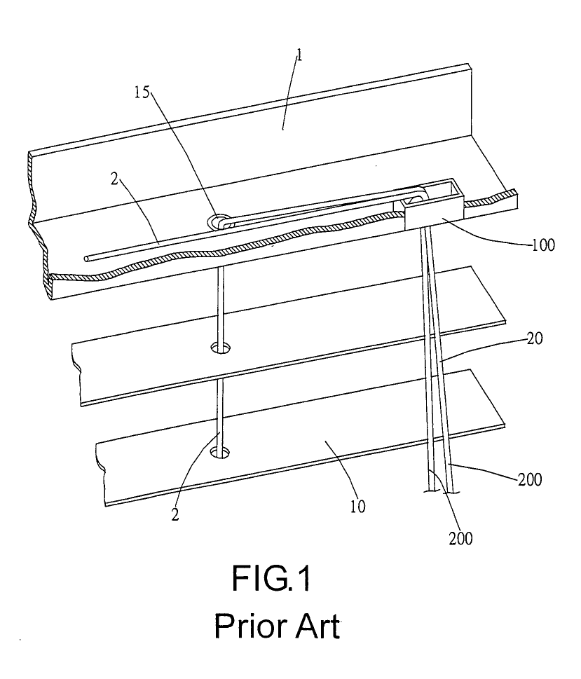

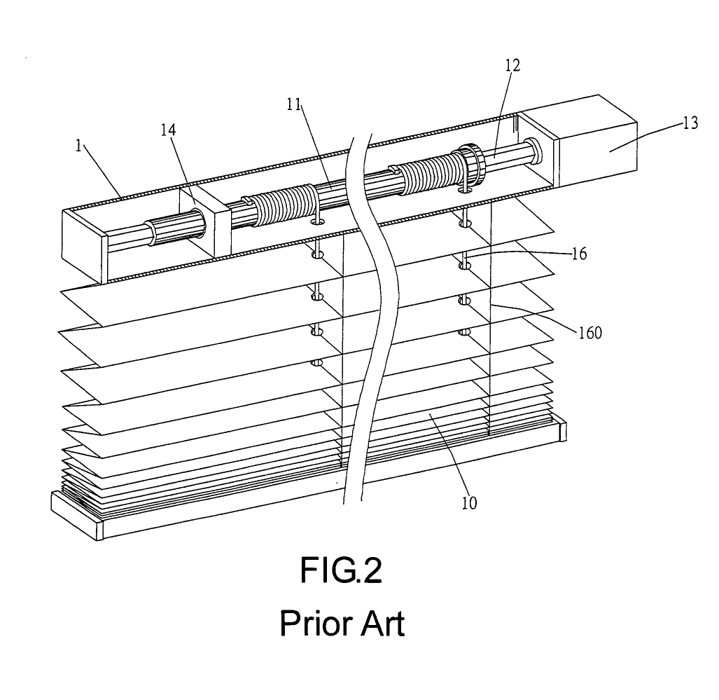

### DETAILED DESCRIPTION OF THE PREFERRED EMBODIMENTS

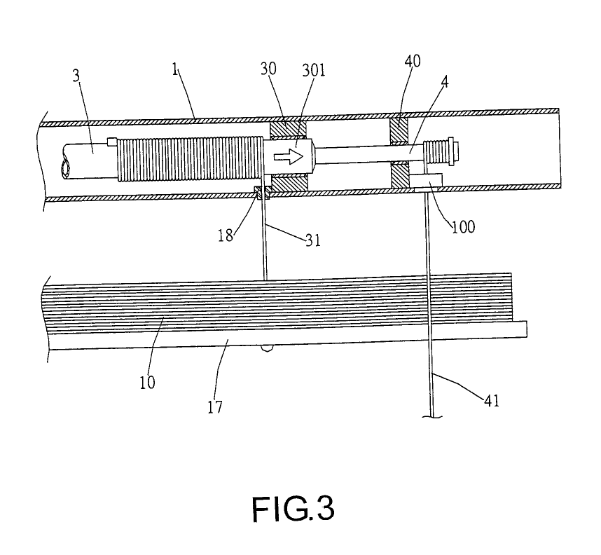

Referring to FIG. 3, a release shaft 3 is located on a sliding seat 30 which is installed in a top rail 1. The release shaft 3 is coaxially connected to an activation shaft 4 with a smaller diameter. The activation shaft 4 is supported by another corresponding slide seat 40. An outer surface of the release shaft 3 provides for winding a lifting cord 31 whose free end passes through a shed 18 installed in the top rail 1 and which is linked downward to slats 10, with a terminal free end connected to a bottom rail 17. The activation shaft provides for winding an activation cord 41 which passes through an arresting member 100 located on the top rail 1. The arresting member 100 is a conventional arresting member and its function is to lock on any position of a section of the activation cord 41, such that when pulling down the activation cord 41, it should be shifted by an angle to escape from the arresting member 100. As the operation of arresting member 100 is an ordinary design, it will not be described further.

The activation cord 41 wound around the activation shaft 4 will move up and down alternatively, relative to the lifting cord 31 on the release shaft 3. Therefore, when dropping down the slats 10, the release shaft 3 will be rotated accordingly, which in turn Will drive the activation shaft 4 to rotate in a same direction simultaneously.

When the slats 10 drop down due to their deadweights, the lifting cord 31 will be limited by the position of shed 18. Therefore, when the release shaft 3 is pulled by the lifting cord 31, it will be pushed rightward according to its sidelong component of force, which will in turn extend the activation shaft 4 rightward. In addition, as the activation cord 41 located on the activation shaft 4 will be collected when dropping down the slats 10, and the release shaft 3 will move rightward, hence there will be no overlapping between each strand of activation cord 41, thereby constituting a spiral shape collection.

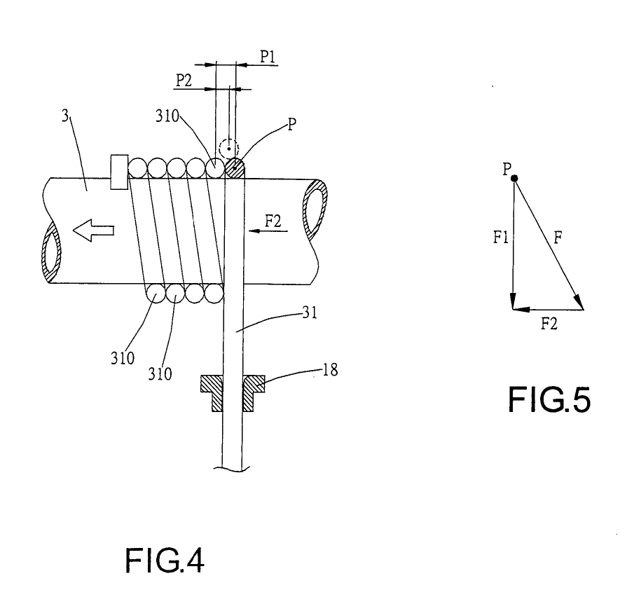

Referring to FIG. 4, when the lifting cord 31 is collected on the outer surface of release shaft 3, a series of strands 310 aligned next to each other will be formed between a last strand 310 and the lifting cord 31. During a process of collection, as the lifting cord 31 is positioned by the shed 18 and when an upper end of lifting cord 31 is wound on an initial position of the release shaft 3, a sidelong shear will be formed at a previous strand 310, resulting in a distance P2 before shearing and a distance P1 after shearing. Pluralities of strands 310 are aligned with an equal distance P1, and a position of point of action P will be changed into a position on an upper surface of release shaft 3, due to a sidelong shear.

Referring to FIG. 5, during a process of shifting the point of action P, a sidelong force of action F will be formed, which is composed of a vertical component of force F1 and a horizontal component of force F2 caused by the lifting cord 31. The horizontal force of action F2 branched out from the sidelong force of action F will be acting on a left side. Therefore, as shown in FIG. 4, the force of action F2 will push a previous strand 310. As each strand 310 is winding on the outer surface of release shaft 3 which can freely slide as a free body in a longitudinal direction, the release shaft 3 will be pushed leftward by subjecting to the horizontal force of action F2.

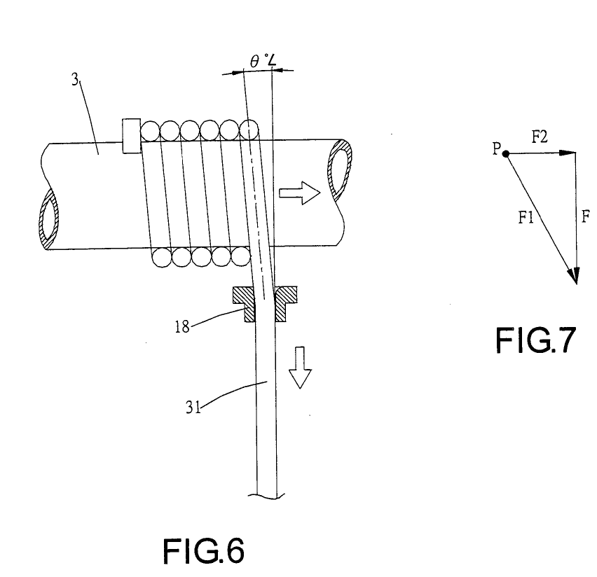

Referring to FIG. 6, when the lifting cord 31 is pulled down by an external force, a sidelong angle θ will be formed at the lifting cord 31 between the shed 18 and release shaft 3, due to a positioning of shed 18 and a resistance force resulted from a horizontal shifting of release shaft 3.

Referring to FIG. 7, a downward vertical force of action F of the lifting cord 31 will be decomposed into a sidelong component of force F1 and a horizontal component of force F2 due to the aforementioned factors. Similarly, the horizontal component of force F2 will result in a rightward force through the sidelong component of force F1 and the force of action F, so as to push the release shaft 3 rightward.

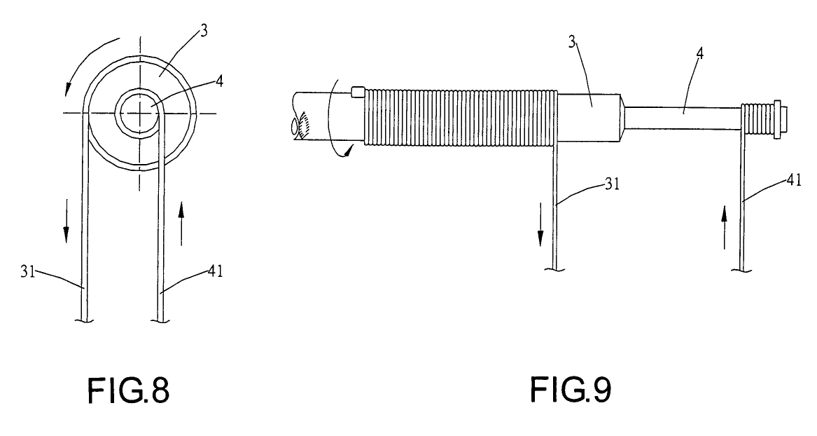

Referring to FIG. 8, the activation shaft 4 is coaxially connected to the release shaft 3. Therefore, when the activation cord 41 is winding on the activation shaft 4 clockwise, the lifting cord 31 will be winding on the outer surface of release shaft 3 counterclockwise.

Referring to FIG. 9, as the release cord 31 and the activation cord 41 are winding on the release shaft 3 and the activation shaft 4 in different direction, when the release shaft 3 is rotating counterclockwise and the lifting cord is moving downward, the activation cord 41 will be pulled up and collected. On the contrary, if the activation cord 41 is pulled down, the release shaft 3 will collect the lifting cord 31.

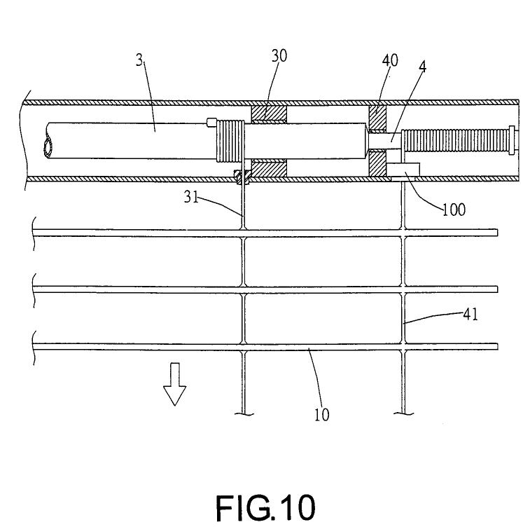

Referring to FIG. 10, it shows a schematic view of dropping down the slats. Similarly to dropping down the slats 10 due to the deadweight effect as shown in FIG. 3, a locking status of the activation cord 41 by the arresting member 100 must be removed, so as to enable the activation cord 41 to freely move up. Whereas, the lifting cord 31 will pull the release shaft 3 through a downward movement of slats 10, and push the release shaft 3 rightward according to the working principle depicted in FIG. 6, which will in turn extend the activation shaft 4 rightward. Moreover, due to the working principles depicted in FIG. 8 and FIG. 9, the activation shaft 4 will collect the activation cord 41. On the other hand, upon collecting the slats 10, the activation cord 41 will be escaped from the arresting member 100 and pulled, and simultaneously rotate the release shaft 3 through the activation shaft 4, such that the release shaft 3 can collect the lifting cord 31 in a reverse direction, thereby pulling up the slats 10 and achieving a purpose of collecting the slats 10.

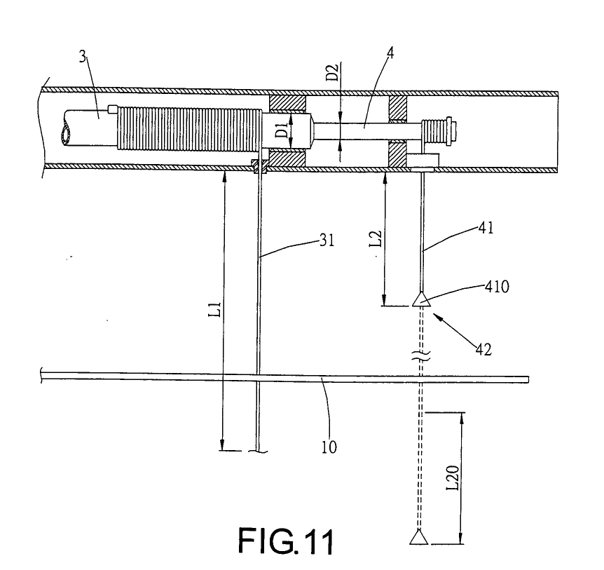

Referring to FIG. 11, a lifting stroke L1 of the lifting cord 31 driven by the release shaft 3 is determined by multiplying a diameter D1 of release shaft 3 by the ratio of the circumference of a circle to the diameter and a rotational speed (L1=π D N). As the release shaft 3 and the activation shaft 4 are connected coaxially, their rotational speeds will be identical. As the diameter D1 of release shaft 3 is larger than the diameter D2 of activation shaft 4, the operation stroke L1 of lifting cord 31 must be greater than a pulling stroke L2 of activation cord 41. If the diameter D1 of release shaft 3 is twice as much as the diameter D2 of activation shaft 4, then the stroke L1 will also be twice as much as the activation stroke L2 of activation cord 41. By taking an advantage that the strokes are not the same, a user can operate the activation cord 41 in a short range to operate a height of opening and closing of a large stroke lifting cord 31. Correspondingly, an operation speed can be enlarged to operate an upward and downward movement of the slats 10.

A stem 410 is fastened to the free end of activation cord 41, so as to facilitate a grab with hands for activation. As the activation cord 41 can be extended downward, and its operation stroke L20 is also located below, therefore for a window blind hanged up in a high position, a user can operate at a position close to a ground, by using this concept.

The concept of providing a grab with the stem 410 at the free end of activation cord 41 can be further applied to a terminal cord winder 42 which is connected to the free end of activation cord 41. A shape of the cord winder 41 is used to provide for grabbing and the cord winder 41 can be an ordinary tool for winding cords, which will not be described further. By using the cord winder 42 to perform collection, the position of stem 410 can be at any height.

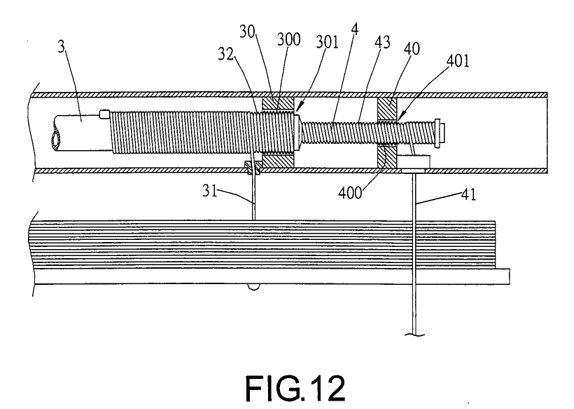

Referring to FIG. 12, a sliding friction exists between the release shaft 3 and the sliding seat 30, such that the release shaft 3 can move rightward and leftward in a longitudinal direction. To further specify that the release shaft 3 can collect the lifting cord 31 in a full pitch, male threads 32 with a pitch equal to the diameter of lifting cord 31 are located on the outer surface of release shaft 3. The male threads 32 are acting on female screws 300 located in the sliding seat 30. By a high sliding rate between the female screws 300 in the sliding seat 30 and the male threads 32, the release shaft 3 can easily move longitudinally according to a specification of male threads, when pulling down the lifting cord 31. The female screws 300 are located in a position with respect to a sliding hole 301. By using the male threads 32 located on the release shaft 3, the lifting cord 31 can be collected in an equal pitch, which in turn can move the activation shaft 4 axially with a uniform pushing velocity.

In addition to the aforementioned implementation of male threads 32 on the outer surface of release shaft 3, the present invention can further install male threads 43 on the outer surface of activation shaft 4. The male threads 43 fit with female screws 400 located at a position of sliding hole 401 of a sliding seat 40, such that the activation cord 41 can be wound on the male threads 43 according to the threads, wherein the activation cord 41 and the lifting cord 31 have the same diameter. If both the release shaft 3 and activation shaft 4 are provided with the male threads 43, their pitch must be identical. However, the diameter of release shaft 3 is larger than that of activation shaft 4.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A single cord activation mechanism for collecting a window blind, more particularly a mechanism which uses a single cord to collect slats of a window blind in high speed, comprising primarily a top rail whose lower end is provided with pluralities of slats linked to a release shaft through a lifting cord; an activation shaft, with a diameter smaller than that of the release shaft, being connected to the release shaft coaxially; the activation shaft being activated by a single activation cord through an arresting member and the lifting cord being positioned by a shed located on the top rail.

2. The single cord activation mechanism for collecting a window blind according to claim 1, wherein the release shaft and the activation shaft are supported by sliding seats located on the top rail.

3. The single cord activation mechanism for collecting a window blind according to claim 1, wherein the release shaft is further provided with male threads which are fitted with female screws located at the sliding seat.

4. The single cord activation mechanism for collecting a window blind according to claim 3, wherein the pitch of male threads is the same as the diameter of release cord.

5. The single cord activation mechanism for collecting a window blind according to claim 1, wherein the activation shaft is further provided With male threads.

6. The single cord activation mechanism for collecting a window blind according to claim 5, wherein the pitch of male threads is the same as the diameter of activation cord.

7. The single cord activation mechanism for collecting a window blind according to claim 1, wherein the diameters of cross sections of the lifting cord and the activation cord are equal.

8. The single cord activation mechanism for collecting a window blind according to claim 4, wherein the diameters of cross sections of the lifting cord and the activation cord are equal.

9. The single cord activation mechanism for collecting a window blind according to claim 6, wherein the diameters of cross sections of the lifting cord and the activation cord are equal.

10. The single cord activation mechanism for collecting a window blind according to claim 3, wherein the pitch of male threads of release shaft and activation shaft are equal.

11. The single cord activation mechanism for collecting a window blind according to claim 5, wherein the pitch of male threads of release shaft and activation shaft are equal.

12. The single cord activation mechanism for collecting a window blind according to claim 1, wherein a cord winder can be located at a free end of activation cord.

13. The single cord activation mechanism for collecting a window blind according to claim 12, wherein the shape of cord winder can be a stem.
